(19) United States
(12) Patent Application Publication
(10) Pub. No.: US 2006/0021930 A1
(43) Pub. Date: Feb. 2, 2006

(54) Coffee paper filters and method of use

(76) Inventors: Edward Z. Cai, Camas, WA (US); Rick Van Abkoude, Corvallis, OR (US)

Correspondence Address: Edward Z. Cai, 4607 SE Autumn CT, Camas, WA, 98607, US

(21) Appl. No.: 10/903,511

(22) Filed: Jul. 30, 2004

(51) Int. Cl. B01D 25/00

(52) U.S. Cl. 210/323.1; 210/483; 210/248; 210/488; 210/470; 210/464; 210/473

(57) ABSTRACT

A pack of coffee paper filters to enable consumers to use freshly ground coffee beans to brew coffee in coffeemakers designed to use pre-packaged coffee pods comprises a stack of pan-shaped paper filters having a rim and a chamber adapted to receive various amounts of coffee beans to achieve the desired brew strength, a stack of overflow prevention sheets having a plurality of overflow stoppers connected to the sheet by bridges, and a container having a chamber to position the stack of pan-shaped filters, a guide chamber for guiding and aligning a seal presser with the rim of the pan-shaped filter and a seal platform for supporting the rim. The overflow stopper has a water permeable center portion, a sufficiently soft rim larger than rim of the pan-shaped filter and an adhesive ring at the rim on the rim. Another aspect of the invention is a method of using the pack of coffee filters to make a pod directly in the holder of the coffeemaker during a brewing process, which includes placing a pan-shaped filter into the holder, adding to the pan-shaped filter a desired amount of freshly ground coffee beans for a desired coffee strength, placing an overflow stopper into the holder, closing the brew head of the coffeemaker to cause the overflow stopper to seal to the pan-shaped filter to form the pod.

### FIELD OF THE INVENTION

This is a continuation-in-part application of the application titled “coffee filter paper and method of use” that was filed on Jul. 20, 2004.

### BACKGROUND OF THE INVENTION

Coffee filter papers, such as cup-like paper filters or cone-like filters, have an open top for receiving coffee grounds and for allowing hot water to drip into the filter to extract the grounds therein. Such filters tends to cause coffee grounds to overflow the rim of the filter paper into a cup or carafe when too much or too fine grounds is used or when the paper filter collapsed during brewing.

Numerous efforts have been made in the prior art to address the grounds overflow problem above. Sandvig [U.S. Pat. No. 4,728,425], Bielfeldt et al [U.S. Pat. No. 6,189,438], Katapka [U.S. Pat. No. 6,705,471] and Spiteri Antonio [U.S. Pat. application Ser. No. 20020185010] taught a retainer, a filter support, a blind-end frame and a set of longitudinal folds, respectively, to prevent filter collapse. Rainer and Dolfel in U.S. Pat. applications Ser. Nos. 20020066700 and 20020189461 taught to use higher permeability material in upper region of the filter and perforations on the filter, respectively, to prevent coffee grounds overflow. Hugentobler [U.S. Pat. No. 5,582,730] taught a distribution cover for a filter basket to obtain more uniform water distribution and limit coffee grounds overflow. The improved coffee filters, however, require a large filter size, which in turn requires the brew station to be large and bulky. In addition, the improved filters are still prone to coffee grounds overflow, especially when the hot water is delivered to the filter under pressure at high flow.

Rehman et al. in U.S. Pat. No. 5,012,629, Gruenbacher in U.S. Pat. No. 5,633,026, Black & Decker in its Home Café® machines and Philips in its Senseo® machines taught various coffee pods comprised of a predetermined amount of coffee grounds pre-packaged between two paper filters, thus preventing any overflow of coffee grounds out of the filter during brewing. The coffee pod, however, disallows consumers to use different amounts of coffee grounds to brew their desired strength of coffee. It also prevents consumers from being able to use their favorite coffee beans from their preferred coffee roasters. Moreover, the grounds in the coffee pods are not freshly ground and roasted.

The present invention is to provide consumers a new coffee filter paper to resolve the grounds overflow problem without the drawbacks and limitations of the prior art.

### SUMMARY OF THE INVENTION

The invention provides a pack of paper filters to enable consumers to use various amounts of fresh ground coffee beans from their preferred roasters to brew coffee in coffeemakers designed to use pre-packaged, not as fresh coffee pods. The filter pack comprises a stack of pan-shaped paper filters and a stack of overflow prevention sheets in a container covered by a lid film with a tab. The pan-shaped paper filter comprises a rim and a chamber to receive the fresh ground coffee beans. The rim of the pan-shaped paper filter comprises a plurality of folds where the adjacent paper layers in each fold are attached to each other via either an adhesive coating or embedded adhesive fibers to maintain the shape of the pan-shaped filter.

The overflow prevention sheet comprises one or more overflow stoppers spaced apart from the sheet by two or more line spaces and connected to the sheet by two or more breakable bridges, four sufficiently stiff sides for accurate positioning and alignment, and line spaces around the overflow stopper. The overflow stopper has a water permeable center portion, a rim, an adhesive ring at the rim for forming adhesive bonds to the rim of the pan-shaped filter, and four breakable bridges to connect to the sheet. To prevent the breaking of the resulting pods during the removal of the resulting pod attached to the sheet, the outer periphery of the overflow stopper is made at least 0.01 inches larger, preferably at least 0.04 inches larger than that of the pan-shaped filter. To prevent delamination of the pod during the brewing process or handling, the rim for the overflow stopper may be made substantially more flexible than the center portion.

The container comprises a chamber to precisely position the stack of pan-shaped filters, a guide chamber for guiding and aligning a seal presser with the rim of the pan-shaped filter in the chamber, and a seal platform for supporting the rim of the pan-shaped filter. The sealing presser has a handle, a body plate and a sealing ring protruding out of the lower surface of the body plate. One or more heating elements, controlled by a pressure sensitive micro-switch, are incorporated in either the seal platform of the container or the sealing ring of the sealing presser for activating the adhesive ring on the overflow stopper after proper alignment has been obtained among the seal platform, the sealing ring, the rim of the pan-shaped filter and the rim of the overflow stopper in the container by the guiding chamber.

To use the filter pack to brew coffee with fresh ground coffee beans, one removes the lid film for the container and measures with a spoon or scooper a desired amount of fresh ground coffee beans, which may vary from about 4 to 10 grams, into the top pan-shaped filter in the stack in the container. After placing one overflow prevention sheet into the container, one inserts the sealing presser into container to press the overflow prevention sheet against the top pan-shaped paper filter for several seconds. The guide chamber automatically positions the overflow prevention sheet and the sealing presser to cause alignment of the rim for the overflow stopper and the sealing ring of the presser with the rim of the pan-shaped paper filter. The sealing presser is then removed from and the sheet containing one pod is lifted out of the container. To remove the coffee pod from the pod sheet, one may simply push the pod downward to break the bridges between the overflow stopper and the overflow prevention sheet.

In another embodiment of the invention, the filter pack comprises a plurality of stacks of pan-shaped filters received in a plurality of chambers in the container. Each of the overflow prevention sheets comprises a plurality of overflow stoppers. The sealing presser has a plurality of sealing rings. In use, one fills all the top pan-shaped filters in the stacks of pan-shaped filters with various amounts of fresh ground coffee beans, places one overflow prevention sheet into the container, and insert the seal presser into the container as described above. The resulting pod sheet will contain a plurality of coffee pods attached to it, thus allowing one to make a plurality of coffee pods at a time.

In another embodiment of the invention, the pan-shaped filters and overflow stoppers are adapted to make a coffee pod directly in the holder of the coffeemaker during the brewing process. The rims for the pan-shaped filter and overflow stopper are so dimensioned that the brew heads of the coffeemakers act as the sealing presser. The adhesive ring is made from an adhesive material that is or can become adhesive at a temperature at or below the brewing temperature for the coffee beans. The adhesive material is a pressure sensitive adhesive that is sufficiently hydrophobic to survive the brewing process during which the adhesive ring in close contact with nearly boiling water, and the rims are rendered hydrophobic by coating with a hydrophobic polymer such as poly (ethylene vinyl acetate) or linear low density polyethylene or by embedding hydrophobic polymer fibers such as polyethylene or polypropylene fibers with the paper fibers. To brew, one places a pan-shaped filter into the pod holder for the coffeemaker, adds to the pan-shaped filter a desired amount of freshly ground coffee beans for a desired coffee strength, places and aligns an overflow stopper on to the pan-shaped filter, closes the brew head of the coffeemaker to seal the rim of the overflow stopper to the rim of the pan-shaped filter to form a closed coffee pod, and pump hot water through the pod. The extracted pod is then removed from the holder for disposal just like a pre-packaged coffee pod. In a further embodiment of the invention, the rims for both the pan-shaped filter and overflow stopper are sloped to achieve self alignment between the rims when the overflow stopper is placed onto the pan-shaped filter.

It is an object of the present invention to provide a pack of paper filters to enable consumers to use fresh ground coffee beans to brew coffee in the coffee makers designed to use coffee pods.

It is a further object of the present invention to provide a pack of paper filters to enable consumers to use their favorite coffee beans from their favorite roasters in the coffee makers designed to use coffee pods.

It is a further object of the present invention to provide a pack of paper filters to enable consumers to vary the amount of ground coffee beans to obtain their desired coffee strength in the coffee makers designed to use coffee pods.

It is a further object of the present invention to provide a pack of paper filters to enable consumers to make coffee pods directly in the pod holder of the coffee makers designed to use coffee pods during a brewing process.

It is an object of the present invention to provide a pack of paper filters to prevent any overflow of coffee grounds over the filter paper when the coffee grounds are too fine or the water is delivered too fast to the filter.

These and other objectives and advantages of the present invention will become apparent from the following description of the preferred embodiments, taken together with the accompanying drawings.

### DESCRIPTION OF THE DRAWING

The accompanying drawing illustrates diagrammatically non-limitative embodiment of the invention, as follows:

FIG. 1 is a section view of a pack of coffee paper filters comprising four stacks of pan-shaped filters and one stack of overflow stopper sheets;

FIG. 1a is a section view of the pack of coffee paper filters along line A-A of FIG. 1;

FIG. 1b is a sectional view of the pack of coffee paper filters along line B-B of FIG. 1;

FIG. 1c is a section view of one pan-shaped filter 29 of FIG. 1;

FIG. 1d is a sectional view of one overflow stopper sheet 25 of FIG. 1;

FIG. 1e is the section view of a modified pan-shaped filter;

FIGS. 2-2e are section views showing a process of making coffee pods by consumers or end users using the pack of coffee paper filters of FIG. 1;

FIG. 3 is a sectional view of a sheet of the pan-shaped filters;

FIG. 3a is a sectional view of the sheet of pan-shaped filters along line A-A of FIG. 3.

FIGS. 4-4d are a section views showing a process of making coffee pods by consumers or end users using the sheet of pan-shaped filters of FIG. 3;

FIG. 5 is a section view of a pack of coffee filters comprising one stack of pan-shaped filters and one stack of overflow stoppers according to another embodiment of the invention;

FIGS. 5a-5d are sections of four alternative overflow stoppers;

FIGS. 6-6b are section views showing a process of making coffee pods by consumers or end users using the pack of coffee filters of FIG. 5;

FIG. 7a is a section view of a stack of three modified pan-shaped filters;

FIG. 7b is a section view of a stack of two modified overflow stoppers.

FIG. 8 is a section view of a stack of six combined sheets of pan-shaped filters and overflow stoppers;

FIG. 8a is a section view of the stack of six combined sheets along A-A of FIG. 8.

### DETAILED DESCRIPTION OF THE PREFERRED EMBODIMENTS

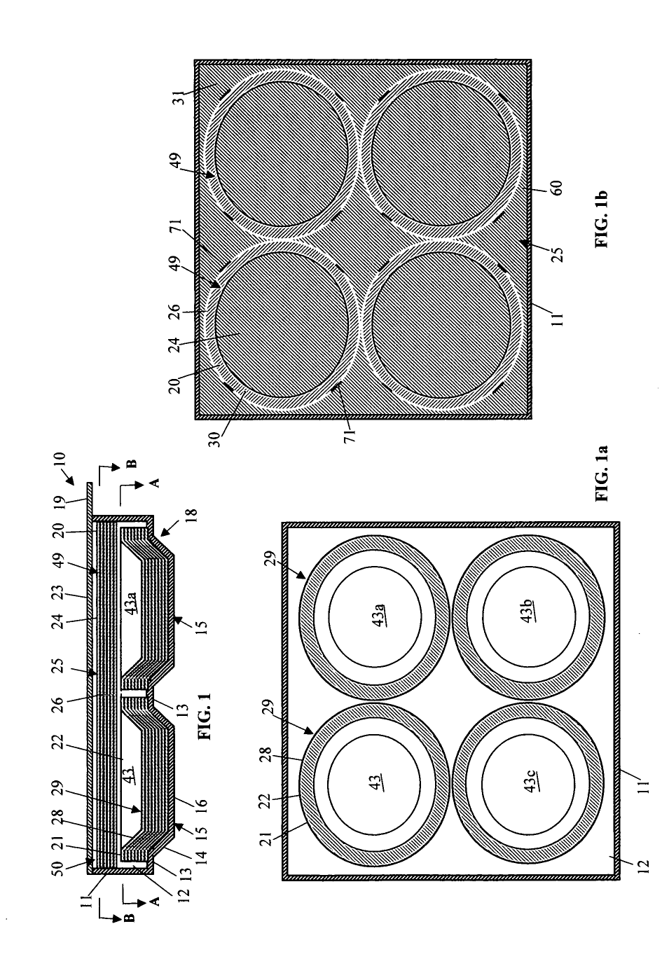

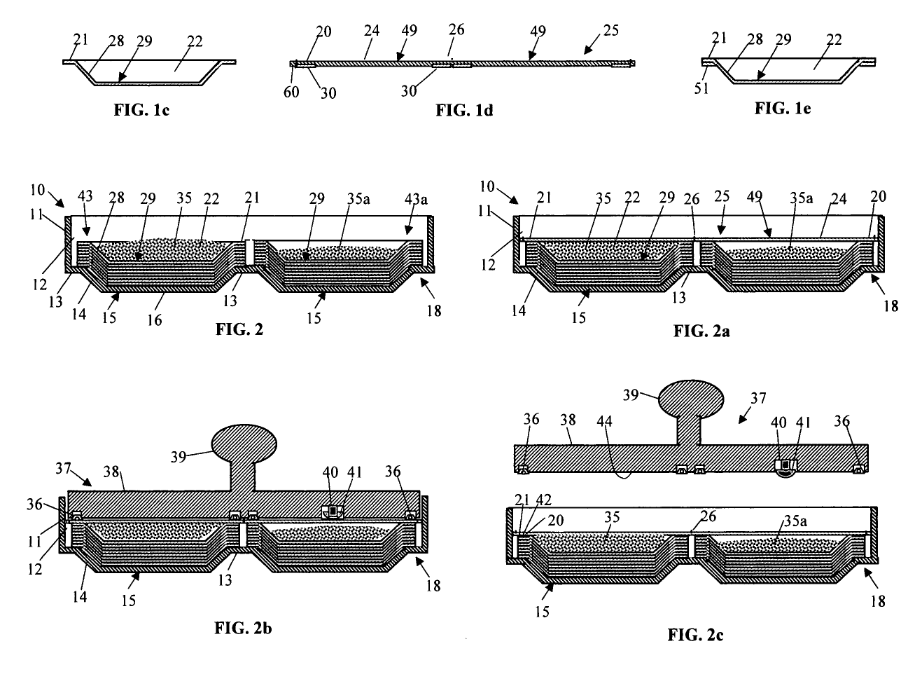

FIGS. 1-1d illustrate a pack of coffee paper filters 10 comprising four stacks 43, 43a, 43b and 43c of pan-shaped paper filters 29, as best viewed in FIGS. 1, 1a and 1c, and one stack 50 of overflow prevention sheets 25, as best viewed in FIGS. 1, 1b and 1d, in a container 18 covered by a lid film 23 with a tab 19. The filter pack is to enable consumers to use any desired amount of their favorite brands of fresh coffee beans to brew coffee of desired strength in coffeemakers that use coffee pods. Each of the four stacks 43-43c has about the same number of pan-shaped filters 29 to achieve about the same height to facilitate the sealing of an overflow prevention sheet to the pan-shaped filters in container 18 during use.

Each of the pan-shaped paper filters (FIG. 1c) comprises a rim 21 and a chamber 22 having a side wall 28, a closed bottom and a large top opening to allow one to add the fresh ground coffee beans into the chamber. The pan-shaped paper filter also comprises a plurality of folds (not shown) on the rim 21 and side wall 28 as a result of forming the chamber 22 from a flat sheet of filter paper. The adjacent paper layers in each fold are attached to each other, which proved critical in maintaining the shape of the pan-shaped filter during storage and handling. The layers in the fold may be attached together by compressing the layers between male and female molds under pressure and heat. Adhesive on or imbedded in the pan-shaped filter paper was found to facilitate the attachment of the adjacent layers in the folds. FIG. 1e shows the use of an alternative heat activable film ring 51, such as a poly(vinyl acetate) or polyethylene ring, attached to the underside of the rim 21 of the pan-shaped paper filter 29 to fix the folds on the rim 21.

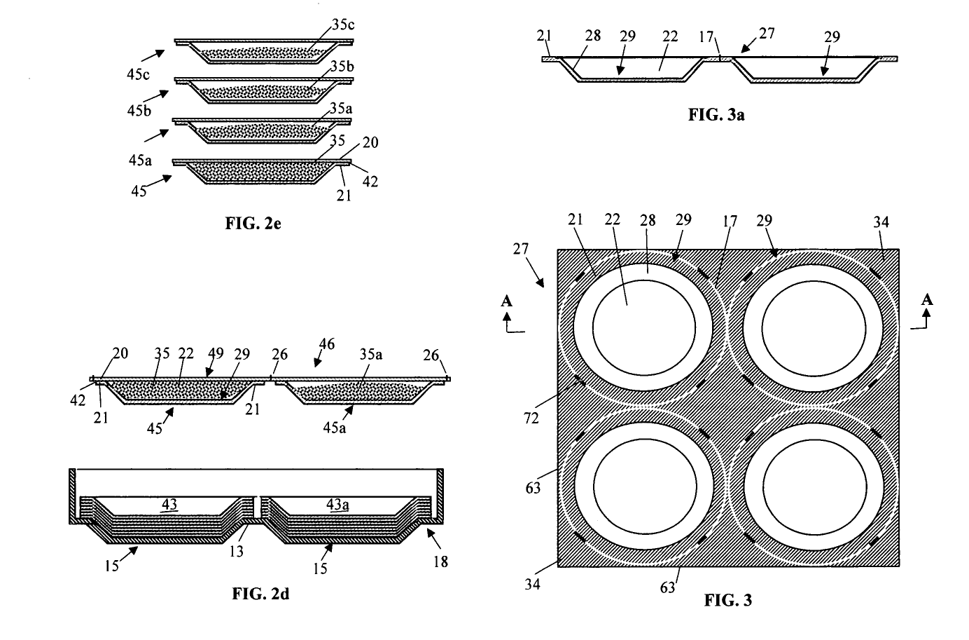

The container 18 comprises four chambers 15 to precisely position the four stacks 43, 43a, 43b and 43c to restrict their movement. Each chamber 15 has a bottom 16 and a side wall 14 for supporting the bottom and side wall of the pan-shaped filters 29, and a seal platform 13 for supporting the rim 21 for enabling the sealing operation. The container 18 also has a guiding chamber 12 defined by side walls 11 for guiding and positioning a seal presser 37, to be discussed in more details in FIGS. 2-2e.

Each overflow prevention sheet 25 comprises four overflow stoppers 49 spaced apart from the sheet by cuts or line spaces 26 and connected to the sheet by breakable bridges 71. Each overflow stopper comprises a water permeable center portion 24, a rim 20, and an adhesive ring 30 at the rim 20 (FIGS. 1b and 1d). The adhesive ring 30 may be an adhesive coating on the lower surface of the rim 20, and the adhesive ring may become unnecessary if the overflow prevention sheet 25 is made from a filter paper that already contains adhesive or hot melt polymer fibers or an adhesive coating. The sheet 25 also has four sides 60 and four corners 31. The sides 60 may be made significantly stiffer than the overflow stoppers to facilitate the breaking of the bridges 71, thus facilitating the removal of the coffee pods from the overflow prevention sheet as will be discussed in FIG. 2d. One of the fours corners is bent upward (not shown) to facilitate removal of the overflow prevention sheet and the pods attached to the sheet from the container 18. The outer periphery of rim 20 for the overflow stopper is about 0.02 to 0.1 inches larger than the outer periphery of rim 21 for the pan-shaped filter to facilitate the removal of the coffee pod from the overflow prevention sheet 25 without damaging the pod.

FIGS. 2-2e show the process of using the filter pack 10 to make fresh coffee pods containing various amounts of freshly ground coffee beans of one's favorite brands at one's homes. After removing lid film 23 and the stack 50 of the overflow stoppers 29 from container 18, one measures four desired amounts of fresh ground coffee beans 35, 35a, 35b and 35c, which may vary from about 4 to 10 grams, with a spoon or scooper to the four pan-shaped filters 29 on top of the stacks 43 to 43c (FIG. 2). One then places one overflow prevention sheet 25 into container 18 to cover the stacks 43-43c and ground beans 35-35c (FIG. 2a). The guiding chamber 12 is dimensioned to position the overflow prevention sheet to cause the rims 20 of the overflow stoppers 29 to substantially align with the rims 21 of the pan-shaped paper filters.

One then inserts a sealing presser 37 into container 18 to attach the overflow prevention sheet 25 to the top pan-shaped paper filters 29 (FIG. 2b). The presser comprises a handle 39, a square plate 38, four sealing rings 36, and a micro-switch 41 housed in a cavity 40 in plate 38. The sealing rings protrude out of the lower surface of the plate to facilitate the sealing. The micro-switch 41 is pressure sensitive to allow it to turn on the electricity to heat the sealing rings 36 when one presses the handle. The guiding chamber aligns the sealing rings 36 to the rims 20 of the four overflow stoppers on sheet 25. After the sealing presser is pressed for 5 seconds to achieve sufficient adhesion bonds 42 between the rims 20 and 21, it is removed from container 18 (FIG. 2c). A pod sheet 46 that has four coffee pods in it is therefore formed.

The pod sheet 46, which has four coffee pods 45-45c containing different amountss of fresh ground coffee beans 35-35c, respectively, can be lifted out of the container by picking the upward-bent corner 31 of the overflow prevention sheet 50 (FIGS. 2d and 2e). It was found that the pod sheet with the four coffee pods could also be removed from container 18 by tilting or turning the container upside down. To remove the coffee pod 45-45c, one may simply push the pods downward to break bridges 71 between the overflow stopper 49 and the overflow prevention sheet 25. It was found that by making the sides 60 of the overflow prevention sheet stiffer than the overflow stoppers, there is significantly less chance for the coffee pods 45-45c to break during the removal of the pods.

To prevent the breaking and delamination of pods 45-45c during their removal from pod sheet 46, the outer diameter for rim 20 should be at least 0.01 inches larger, preferably at least 0.04 inches larger, than the outer diameter for rim 21. Such difference in diameter for rims 20 and 21 is especially important in any of the following situations when

1) there is adhesive material outside the overflow stoppers 49 in the overflow prevention sheet 25;

2) the pan-shaped filter 29 contains adhesive materials such as adhesive fibers or coatings made from poly(vinyl acetate), polyethylene or other adhesive polymers; and

3) At least one of the overflow prevention sheet 25 and pan-shaped filter 29 is made from a filter paper that already comprises adhesive or hot melt fibers mixed with the paper fibers or an adhesive coating. It is appreciated that in this case the adhesive ring 30 on the overflow stopper 49 may not be needed.

In the cases that the pan-shaped filter 29 contains materials that can become adhesive under the conditions when presser 37 is used to seal the rim 20 to rim 21, a ring-shaped release sheet or layer (e.g. release paper) should be placed between the rims 21 of the pan-shaped filters 29 or be coated on the lower surface of the rims 21. Without such a release layer, the pan-shaped filters near the top end of the stacks 43-43c may stick to the pod sheet 46, causing not only waste of pan-shaped filters but also undesirably high water flow resistance for the resulting pods 45-45c.

It is appreciated that it is also possible to prevent the breaking and delamination of pods 45-45c during their removal from pod sheet 46 by selecting the appropriate filter paper for pan-shaped filters 29. It was found that if the selected filter paper for the pan-shaped filters contains no material that can become adhesive under the conditions when the presser 37 is used to seal the rim 20 to rim 21, the removal of the coffee pods from pod sheet 46 can be successfully performed even if the rim 20 of the overflow stopper has a smaller outer diameter than the rim 21 of the pan-shaped filters 29. It is also appreciated that it is possible to prevent pods 45-45c from breaking during their removal from pod sheet 46 by making the outer peripheries for the overflow stopper 49 and pan-shaped filter 29 larger than the outer periphery of the sealing ring 36 for the presser 37.

In FIGS. 3 and 3a, a filter sheet 27 comprising four pan-shaped filters 29, four sides 63 and four corners 34 are presented. Each pan-shaped filter is separated from the filter sheet by four line spaces 17 and connected to the filter sheet by four breakable bridges 72. In this and other embodiments, it is appreciated that the pan-shaped filters 29 can also have a rounded bottom or side wall. It is also appreciated that the chamber 22 of the pan-shaped filter can be made sufficiently deep to hold 15 grams or more ground coffee beans for a richer or larger cup of coffee. It is also appreciated that in this and other embodiments other particle materials such as tea, herb or cocoa may be used, and for simplicity the term ‘fresh ground coffee beans’ is used to represent consumer ground coffee beans, pre-ground coffee beans and other particle materials and the term ‘coffee pod’ or ‘coffee pods’ is used to represent any beverage pod in both the description and claims.

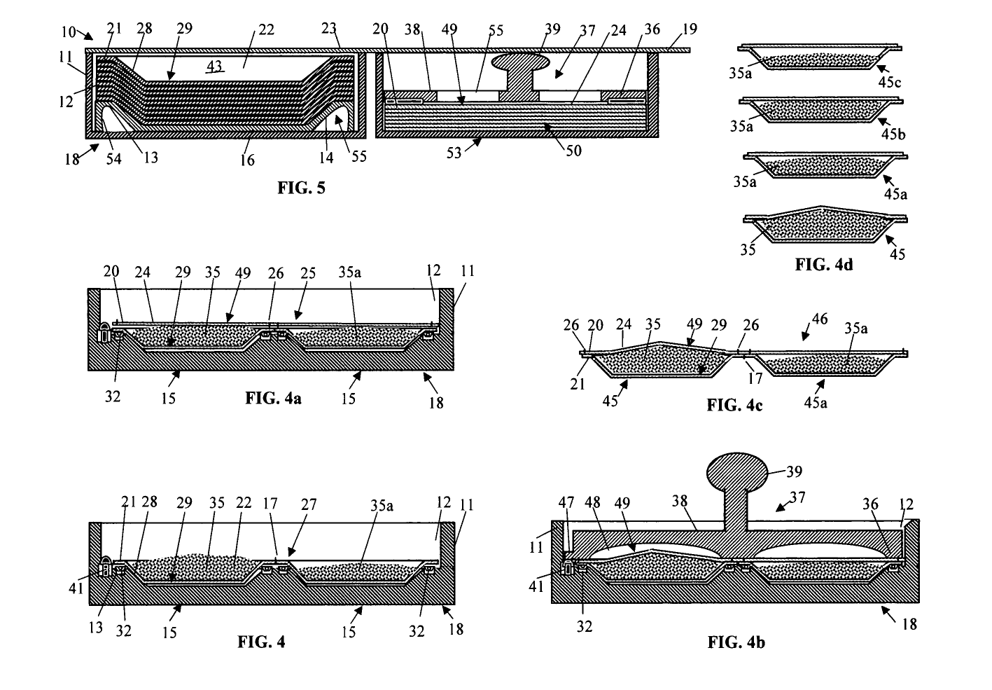

FIGS. 4-4c show a process of using overflow prevention sheet 25 of FIG. 1 and filter sheet 27 of FIG. 3 to make fresh coffee pods containing various amounts of freshly ground coffee beans at homes. The container 18 comprises four chambers 15, four sealing platforms 13 around the four chambers, four ring-shaped heating bars 32 for the four sealing platforms, square guide chamber 12 surrounded by four side walls 11, and micro-switch 41 for controlling the power to the heating bars (FIG. 4). The presser 37 comprises handle 39, square plate 38, four sealing rings 36, four cavities 48 surrounded by the four sealing rings for allowing preparation of thicker coffee pods, and a protrusion 47 for turning on micro-switch 41.

In operation, one places a filter sheet 27 into container 18. The guiding chamber 12 aligns the sheet so that the four pan-shaped filters are received by the four chambers 15 and the rims 21 rest on sealing platforms 13. Four desired amounts of fresh ground coffee beans 35-35c, varying from 4 to 10 grams, are added to pan-shaped filters 29 with a spoon or scooper (FIG. 4). An overflow prevention sheet 25 is placed into container 18, and the guiding chamber aligns the sheet so that the four overflow stoppers 49 are aligned with the four pan-shaped filters (FIG. 4a). Here, the outer diameter for the rims 20 is smaller than that for the rims 21.

After inserting presser 37 into container 18 and pressing it for ˜5 seconds, the rims 20 for the four overflow stoppers are sealed to the rims 21 for the four pan-shaped paper filters (FIG. 4b). During insertion, the guiding chamber helps aligning the sealing rings 36 of the presser with the rims 20. During the pressing, aprotrusion 47 turns on micro-switch 41 to supply electricity to the heating bars 32. After removing the presser, a pod sheet 46 having four coffee pods 45, 45a, 45b and 45c, containing different amountss of fresh ground coffee beans 35, 35a, 35b and 35c, respectively, is lifted out of container 18 (FIG. 4c). The coffee pods can be readily removed from the pod sheet by simply pushing the pods downward to break the bridges 71 on the overflow prevention sheet 25 and the bridges 72 on the filter sheets. The resulting coffee pods 45, 45a, 45b and 45c are shown in FIG. 4d.

To prevent the breaking and delamination of pods 45-45c during their removal from pod sheet 46, the adhesive should be confined within the overflow stoppers in the overflow prevention sheet 25 and the outer diameter for the rim 20 of each overflow stopper should be smaller, preferably at least about 0.02 inches smaller, than the outer diameter for the rim 21 of the pan-shaped filter 29. It is appreciated, however, that by making the outer diameters for both the rim 20 and rim 21 larger than the outer diameter for the heating bar 32 or the sealing ring 36, the removal of pods 45-45c becomes less or in-sensitive to the relative size of the rims 20 and 21. It is also appreciated that four separate pan-shaped filters 29 such as those described in FIG. 1, rather than a filter sheet 27, may be placed in the four chambers 15 of the container.

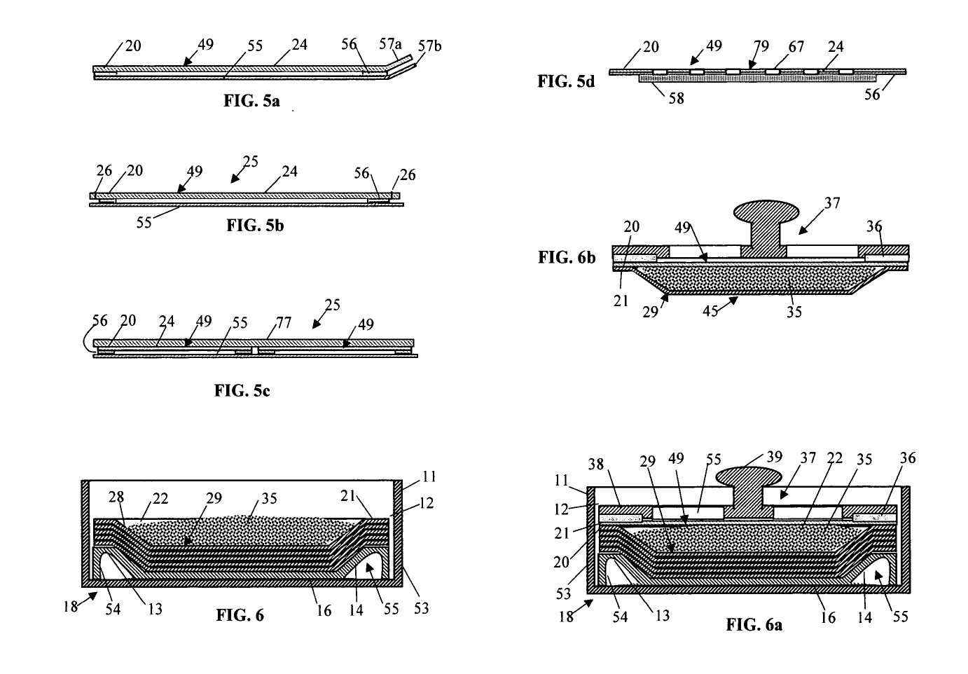

In FIG. 5, a pack of coffee filters 10 comprising one stack 43 of pan-shaped filters 29 received in container 18 and one stack 50 of overflow stoppers 29 received in container 53 is presented. An insert 55 comprising side wall 14, seal platform 13 and a support wall 54 is placed on the bottom of container 18. A sealing presser 37 is placed above the stack of overflow stoppers 49 in the container 53. Both the containers 18 and 53 are sealed by lid film 23. The sealing presser has a handle 39, a body 38, two large openings 55 formed on the body 38 for improving the sealing operation, and sealing ring 36. The sealing ring is sufficiently tacky on its lower surface to pick up the top one overflow stopper 49 from the stack 50, but is not so adhesive to allow the overflow stopper to be readily peeled off by hand.

FIG. 5a shows the cross-section of one of the overflow stopper s 49 of FIG. 5. It has a porous center portion 24, rim 20, adhesive ring 56, a release layer 55 for covering the adhesive ring, a tab 57a connected to the rim 20, and a tab 57b for the release layer. The adhesive ring 56 comprises a pressure sensitive adhesive. For the adhesive ring to survive the brewing process during which the adhesive ring in close contact with nearly boiling water, it was found that the adhesive should be hydrophobic. Otherwise, the coffee pod made from such overflow stoppers would disintegrate, creating a mess when disposing the used coffee pod. The adhesive ring 56 can be made from a hydrophobic acrylic copolymer emulsion materials such as UCAR Latex 185RG from Dow Chemical Company, hydrophobic polybutadiene, or hydrophobic styrene butadiene rubber adhesives. It was also found that the rims 20 and 21 should be rendered hydrophobic by coating the surfaces with a hydrophobic polymer such as poly (ethylene vinyl acetate) or linear low density polyethylene or by embedding hydrophobic polymer fibers such as polyethylene or polypropylene fibers with the paper fibers. In addition, the rims 20 and 21 may be made from a hydrophobic film to achieve the required hydrophobicity. Furthermore, it was found that the adhesion between the rims 20 and 21 is further improved by making at least one of the rims 20 and 21 not permeable to the hot water by coating their surface with a dense water insoluble film.

To achieve improved bonding to rim 21, the thickness of the pressure sensitive adhesive ring 56 should be at least half the diameter of the fibers constituting the pan-shaped filters 29. To achieve instant bonding between the rim 21 and the adhesive ring 56 on rim 20, an adhesion enhancing layer (not shown) may be coated on the upper surface of the rim 21 of the pan-shaped filters. The enhancing coating may be applied to rim 21 by either spraying or printing a polymeric product comprising polyacrylate, poly(ethylene vinyl acetate) or other polymers.

A method of using filter pack 10 of FIG. 5 to make coffee pods with fresh ground coffee beans is shown in FIGS. 6 to 6b. After removing the lid film 23, a desired amount of freshly ground coffee beans 35 is added into the top pan-shaped filter 29 in container 18 (FIG. 6). One overflow stopper 49 is picked up from container 53 by sealing presser 37 to cause the top one overflow stopper to stick to the tacky sealing ring 36. After removing the release sheet 55, the sealing presser carrying the overflow stopper is inserted into container 18 and pressed against the rim 21 of the pan-shaped filter 29 supported on the sealing platform 13 (FIG. 6a). The guiding chamber 12 positions the sealing presser and the overflow stopper attached to the presser to align the rim 20 and sealing ring 36 to the rim 21. Strong adhesion bonds are instantly formed between the hydrophobic pressure sensitive adhesive in the sealing ring 56 and the top surface of the rim 21. The presser 37 is then removed from container 18 and the completed coffee pod 45 is also carried out of the container by the sealing ring 36 (FIG. 6b). The pod 45 is removed from the presser by slightly pulling the pod downward.

With the hydrophobic pressure sensitive adhesive ring 56 on the rim 20, it was also found that the coffee pod 45 can be made from a pan-shaped filter 29 and overflow stopper 49 during the brewing process. Here, one removes a pan-shaped filter from the container 18 and places it into the pod holder for the coffeemaker. A desired amount of freshly ground coffee beans 35 is added to the pan-shaped filter in the pod holder. After placing and aligning an overflow stopper 49 on to the pan-shaped filter, the brew head of the coffeemaker is closed to cause the brew head to press the rims 21 and 20 on the pod holder, causing the adhesive ring 56 to bond the rims 20 and 21 to form coffee pod 45 right in the pod holder prior to the introduction of hot water to the brew head.

To make the coffee pod 45 during the brewing process in the pod holder, it was also discovered that the pressure sensitive adhesive ring 56 can be replaced by a heat activable adhesive ring such as a hot melt ring that can be activated by the brewing temperature. In this case, the adhesion bonds 42 between the adhesive ring on rim 20 and the rim 21 are formed when the hot water is introduced to the brew head to extract the ground coffee beans.

FIG. 5b shows a square-shaped overflow prevention sheet 25 with one overflow stopper 29 on it. The overflow stopper is separated from the sheet by four line spacers 26 (not shown) and connected to the sheet by four bridges 71 just like that shown in FIG. 1b. To use, one holds one corner of the sheet 25 to peel of the release sheet 55 and then performs the same process described in FIGS. 6-6b. At the end of the process, a pod sheet with one coffee pod 45 on it is formed. One may remove the pod from the pod sheet by breaking the four bridges 71 that connects the pod to the pod sheet.

In FIG. 5c a square overflow prevention sheet 25 having four overflow stoppers 49 removably connected to a support sheet 77 by a weak adhesive to allow the overflow stoppers to be peeled off readily from the overflow prevention sheet. The hydrophobic pressure sensitive adhesive rings 56 for all four overflow stoppers are covered by release sheet 55 to allow a number of such overflow prevention sheets 25 to be stacked over each other. To use with the container 18 of FIG. 6 to makes one coffee pod at a time, one may remove one overflow stopper 49 at a time form the sheet 77. It is appreciated that the overflow prevention sheet 25 here may be used to replace overflow prevention sheet 25 of FIGS. 1 and 1d for use with the container 18 of FIG. 2 or with the container 18 of FIG. 3 to make four coffee pods 45, 45a, 45b and 4c at a time. Due to instant nature of the hydrophobic pressure sensitive adhesive rings 56, no electricity or heating is needed to seal the overflow prevention sheet 25 of FIG. 5c to the overflow stoppers 29.

FIG. 5d shows another alternative overflow stopper 49. This alternative comprises a highly flexible film 79 having an ring-shaped edge section functioning as the rim 20 for the overflow stopper and a center portion 24 with openings 67, a filter paper disc 58 attached to the center portion of the flexible film, and a pressure sensitive adhesive layer 56 on the lower surface of the rim. It was discovered that the high flexibility of the film 79 made the seal between the rims 20 and 21 significantly less prone to delamination or de-sealing during handling or accidental drop of the coffee pods 45. Besides preventing any overflowing of coffee grounds during discovered that by making the paper disc 79 thicker or more rigid than the rims 20 and 21, the seal between the rims became significantly less prone to delamination or de-sealing during handling or accidental drop of the pods.

The highly flexible film 79 is a soft plastic film (e.g. a low density polyethylene film or a polyethylene vinyl acetate film) of a thickness less than about 0.002 inches, preferably less than 0.0005 inches. It was found that by replacing the plastic film 79 with a thin elastomer film, the seal between the rims 20 and 21 became even less prone to delamination or de-sealing uring handling or accidental drop of the coffee pods. Examples of such elastomer films are butyl rubber film, thermal plastic elastomer polyethylene film and polyurethane film. To obtain the similar high resistance to delamination, the elastomer film can be made thicker than the plastic film, but it should not be thicker than about 0.01 inches, preferably not thicker than 0.002 inches. It is appreciated that by having the rims 20 and 21 of the overflow stopper and pan-shaped filter in FIGS. 1-6 highly flexible, the seal between the rims become significantly less susceptible to delamination. It is also appreciated that the resistance of the seal between rims 20 and 21 to delamination is further improved if at least one of the rims 20 and 21 is more flexible than the center portion 24 of the overflow stopper.

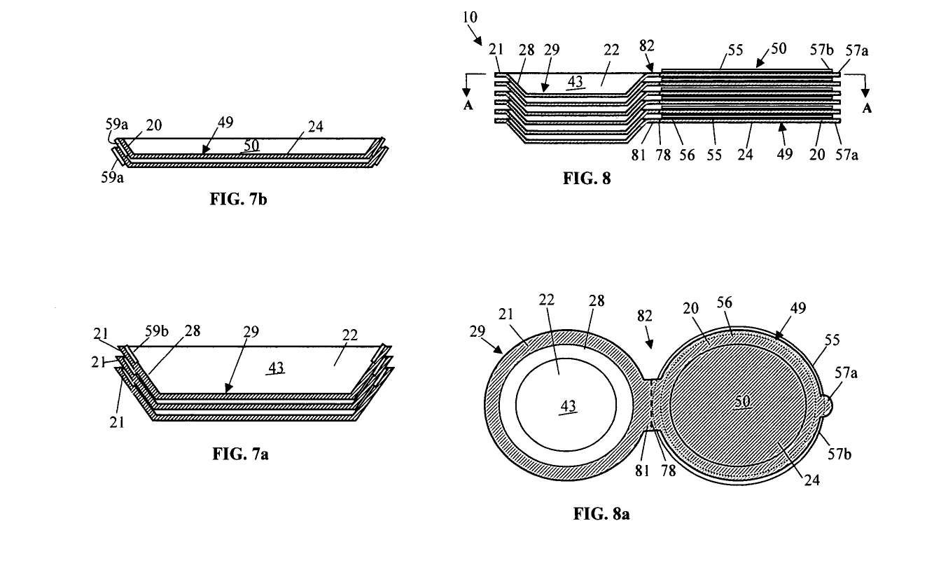

FIGS. 7a and 7b show one stack 43 of three pan-shaped filters 29 and a stack 50 of overflow stoppers 49, respectively. Both the overflow stoppers 49 and pan-shaped filters 49 are made from filter paper. Unlike in the earlier exemplar embodiments where the rims 20 and 21 are horizontal, the rims 20 and 21 here are sloped, which was found to cause self alignment between the rims 20 and 21 when an overflow stopper 49 is placed onto the pan-shaped filters 29. Adhesive layers 59a and 59b are provided on the rim 20 and 21, respectively, and are adapted to cause adhesion only when they are pressed together. Adhesive layer 59a on a top overflow stopper does not stick to the overflow stopper below, and adhesive layer 59b on top pan-shaped filter does not stick to the pan-shaped filter below, thereby facilitating the removal of an overflow stopper from stack 50 and a pan-shaped filter from stack 43.

The adhesives 59a and 59b can be a loop/hook type adhesive where adhesive layer 59a comprises numerous microscopic loops coated on the rim 20 and adhesive layer 59b comprises numerous microscopic hooks coated on the rim 21. When pressed together, the microscopic loops and hooks form numerous microscopic loop-hook bonds to seal the rim 21 to rim 20. One example of such loop/hook adhesives is the reclosable fastners from 3M under its Scotchmate brand. The adhesives 59a and 59b can also be a two-part adhesive with the adhesive layer 59a comprises the activator or curing agents and the adhesive layer 59b comprises an adhesive that quickly solidifies when in contact with the curing agents. For example, the adhesive layer 59b is a curable silicone compound such as RTV 11 or RTV 77 and the layer 59a comprises curing agent such as dibutyl tin dilaurate or stannous tin octoate, all of which are available from General Electric Company. It is appreciated that the adhesive layers 59a and 59b can be replaced by heat activable adhesive fibers mixed with the paper fibers in the filter paper, a heat activable adhesive coating on the paper, or by a hydrophobic pressure sensitive adhesive ring on the rim 20.

It was discovered that the self alignment between the rims 20 and 21 significantly improves the preparation of the coffee pod 45 when the pod is made directly in the pod holder of a coffeemaker from the pan-shaped filter 29 and overflow stopper 49. Similar to the method of using the filter pack 10 of FIG. 5, one places one pan-shaped filter 29 into the pod holder, scoops a desired amount of fresh ground coffee beans into the pan-shaped filter, places one overflow stopper 49 into the pan-shaped filter, and closes the brew head to press the rims 21 and 20 to form a coffee pod. The self alignment between rims 21 and 20 was found to have caused significant improvement in the strength and consistency of the adhesion between the rims 20 and 21.

FIGS. 8 and 8a show a pack of coffee filters 10 that comprises six combined sheets 82. Each combined sheet comprises a pan-shaped filter 29 that is identical to those of FIGS. 1 and 1c, an overflow stopper 49 that is similar to that of FIG. 6a, a bridge 81 to connect the pan-shaped filter to the overflow stopper, and a folding line 78. The pan-shaped filters 29 on the combined sheets 82 are stacked over one another to form a stack 43 of pan-shaped filters and the overflow stoppers 49 on the combined sheets are stacked over one another to form a stack 50 of overflow stoppers.

The folding line 78 may be a perforated or thinned line to enable one to readily fold the overflow stopper over on top of the pan-shaped filter after one has added a desired amount of fresh ground coffee beans to the pan-shaped filter. The folding line should be sufficiently long to enable automatic alignment of the rim 20 to rim 21 when the overflow stopper 49 is folded over to cover the pan-shaped filter 29 on the combined sheet 82. The section at the folding line 78 is preferred to be significantly more flexible or to be rendered significantly more flexible than the overflow stopper 49 to prevent movement of the pan-shaped filter 29 of the combined sheet 82 and the ground coffee beans in it when one folds the overflow stopper 49 to cover the pan-shaped filter 29. In this and other embodiments above, it is appreciated that the release sheet 55 may not be needed if the adhesive ring 56 is a hot melt adhesive or other adhesive that is adhesive at ambient environment and the adhesive may be distributed uniformly in or on the overflow stopper, that such hot melt adhesive may be located at the pan-shaped filter or at both the overflow stopper and pan-shaped filter, and that a cavity may be formed on the center portion 24 of the overflow stopper 49.

Like the pan-shaped filters and overflow stoppers of FIGS. 5 and 7, the pan-shaped filters and overflow stoppers in the combined sheets may be used to make coffee pods directly in the coffeemakers during a brewing process. To use, one simply places the pan-shaped filter 29 of a combined sheet 82 into the pod holder of the coffeemaker, scoops a desired amount of fresh ground coffee beans into the pan-shaped filter, removes the release sheet 55 from the overflow stopper 49 to expose the adhesive ring 56, folds the overflow stopper 49 to cover the pan-shaped filter, and closes the brew head of the coffeemaker to press the rim 20 of the overflow stopper to the rim 21 of the pan-shaped filter. If the adhesive ring 56 becomes adhesive only after it is heated by the hot water from the coffeemaker during the brewing process or by other heating objects, overflow stopper would not have a release sheet 55 and the step of removing the release sheet 55 from the overflow stopper 49 would not be needed, thus simplifying the process.

The scope of the invention is obviously not restricted or limited to the embodiments described by way of examples and depicted in the drawings, there being numerous changes, modifications, additions, and applications thereof imaginable within the purview of the claims.

What is claimed is:

1. A pack of coffee filters for enabling consumers to use fresh ground coffee beans to brew coffee in the coffeemakers that use coffee pods comprising:
a plurality of pan-shaped filters, said pan-shaped filter having a bottom, a side wall, a rim and a top opening sufficiently large to allow a consumer to add an amount of fresh ground coffee beans onto said bottom;
a container for said plurality of pan-shaped filters; and
an overflow prevention sheet comprising at least one overflow stopper removable from said sheet, said overflow stopper comprising a center portion permeable to hot water, a rim adapted to attach to said rim of said pan-shaped filter, and a connector for connecting to said overflow prevention sheet.

2. A pack of coffee filters as defined in claim 1 wherein said connector comprises a plurality of breakable bridges between said overflow stopper and said overflow prevention sheet.

3. A pack of coffee filters as defined in claim 1 wherein the outer diameter for said rim of said overflow stopper is larger than the outer diameter for said rim of said pan-shaped filter.

4. A pack of coffee filters as defined in claim 1 wherein said connector comprises an adhesive between said overflow stopper and said overflow prevention sheet, said overflow prevention sheet and adhesive being adapted to allow said overflow stopper to be readily peeled off from said sheet.

5. A pack of coffee filters as defined in claim 1 further comprises at least one filter sheet to which said plurality of pan-shaped filters are connected.

6. A pack of coffee filters as defined in claim 1 wherein at least one of said rim for said overflow stopper and said rim for said pan-shaped filter is larger than the outer periphery of the sealing ring for a presser used to seal said rims.

7. A pack of coffee filters as defined in claim 1 wherein said container comprises a chamber adapted to receive said pan-shaped filters, an opening to allow a user to add fresh ground coffee to a pan-shaped filter, and a seal platform around said chamber to allow the user to press and seal the rim of a overflow stopper to the rim of a pan-shaped filter rested on said platform.

8. A pack of coffee filters for enabling consumers to use any fresh ground coffee beans to brew coffee in the coffeemakers that use coffee pods comprising:
a stack of pan-shaped filters, said pan-shaped filter having a bottom, a side wall, a rim and a top opening sufficiently large to allow a consumer to add an amount of fresh ground coffee beans onto said bottom;
a stack of overflow stoppers, said overflow stopper comprising a center portion permeable to hot water and a rim adapted to seal to said rim of said pan-shaped filter; and
a container comprising a chamber adapted to receive said pan-shaped filter, an opening to allow a user to add fresh ground coffee beans to said pan-shaped filter, and a seal platform for supporting said rim of said pan-shaped filter, said seal platform being adapted to allow a user to press and seal said rim of said overflow stopper to said rim of said pan-shaped filter.

9. A pack of coffee filters as defined in claim 8 wherein said container further comprises a guiding chamber above said chamber, said guide chamber being adapted to guide a presser into said container in such a way that the sealing ring of the presser is substantially aligned with said rim of said top pan-shaped filter.

10. A pack of coffee filters as defined in claim 8 wherein said container further comprises a second chamber adapted to receive said pan-shaped filters and a second seal platform adapted to allow a user to press and seal said rim of said overflow stopper to said rim of said pan-shaped filter, thereby enabling a user to make a plurality of coffee pods at one time.

11. A pack of coffee filters as defined in claim 8 further comprises a seal presser having a handle, a body and at least one sealing ring protruded out of the lower surface said body for pressing and sealing said rim of said overflow stopper to said rim of said pan-shaped filter.

12. A pack of coffee filters for enabling consumers to use fresh ground coffee beans to brew coffee in the coffeemakers that use coffee pods comprising:
a first stack of filters comprising a plurality of pan-shaped filters, each said pan-shaped filter having a chamber with a generally open top end and a rim at or near said generally open top end;
a second stack of filters comprising a plurality of overflow stoppers, each said overflow stopper comprising a center portion permeable to water and a rim around said center portion adapted to seal to said rim of said pan-shaped filter;
a container for said first and second stacks of filters;
an adhesive system adapted to allow a consumer to seal said rim of said overflow stopper to said rim of said pan-shaped filter by simply pressing a sealing presser having a sealing ring onto said rim of said overflow stopper on top of said pan-shaped filter, thereby sealing the fresh ground coffee beans added to said chamber; and
wherein said pan-shaped filter is adapted to allow the consumer to vary the amount of fresh ground coffee beans to be added into said chamber to vary the strength of coffee to be brewed.

13. A pack of coffee filters as defined in claim 12 wherein at least one of said rim for said pan-shaped filter and said rim for said overflow stopper is substantially more flexible than said center portion of said overflow stopper to prevent the delamination or de-sealing of the seal between said rims.

14. A pack of coffee filters as defined in claim 12 wherein said adhesive system comprises a pressure sensitive adhesive layer on said rim of said overflow stopper and a release sheet for covering said pressure sensitive adhesive layer.

15. A pack of coffee filters as defined in claim 14 wherein said pressure sensitive adhesive layer is hydrophobic.

16. A pack of coffee filters as defined in claim 14 wherein at least one of said rims for said pan-shaped filter and overflow stopper is impermeable to water or hydrophobic to prevent the hot water from reaching said pressure sensitive adhesive layer during the brewing process.

17. A pack of coffee filters as defined in claim 14 wherein said pressure sensitive adhesive layer is adapted to allow the brew head of the coffeemaker to press and seal said rims of said pan-shaped filter and overflow stopper in the pod holder of the coffeemaker during the brewing process.

18. A pack of coffee filters as defined in claim 14 wherein said pan-shaped filter further comprises an adhesion enhancing layer on the top surface of its rim, said enhancing layer being adapted to have sufficiently low adhesion to the adjacent pan-shaped filter above said pan-shaped filter.

19. A pack of coffee filters as defined in claim 14 wherein said adhesive system further comprises a handle connected to said overflow stopper to facilitate the removal of said release sheet and the placing of said overflow stopper onto said pan-shaped filter.

20. A pack of coffee filters as defined in claim 12 wherein at least one of said rims for said pan-shaped filter and overflow stopper is made from a thin rubbery or elastomer film to prevent the delamination of the seal between said rims.

21. A pack of coffee filters as defined in claim 12 wherein at least one of said rims for said pan-shaped filter and overflow stopper is made from an extremely flexible and thin film to prevent the delamination of the seal between said rims.

22. A pack of coffee filters as defined in claim 12 wherein said rim of said pan-shaped filter comprises a plurality of folds, the adjacent layers in each of said folds being permanently attached to each other.

23. A pack of coffee filters as defined in claim 12 wherein said adhesive system is adapted to allow the brew head of the coffeemaker to act as the sealing presser to seal said rim of said overflow stopper to said rim of said pan-shaped filter received in a pod holder of the coffeemaker.

24. A pack of coffee filters as defined in claim 12 wherein said adhesive system comprises an adhesive material in or on said overflow stoppers, and wherein said pan-shaped filters contain no material that can become adhesive under the conditions when said rims of said overflow stopper and pan-shaped filter are sealed together by the presser.

25. A pack of coffee filters as defined in claim 12 wherein said adhesive system comprises an adhesive layer on at least one of said pan-shaped filter and overflow stopper, said adhesive layer having a thickness of at least half of the average diameter of the fibers that constitute said pan-shaped filters to prevent delamination of the seal between said rims of said overflow stopper and pan-shaped filter.

26. A pack of coffee filters as defined in claim 12 wherein said adhesive system comprises a first adhesive layer on the top surface of the rim of said pan-shaped filter and a second matching adhesive layer on the lower surface of the rim of said overflow stopper, said first and second adhesive layers being adapted to form strong bonds when in pressed together.

27. A pack of coffee filters as defined in claim 26 wherein said first and second adhesive layers are adapted to form numerous microscopic loop-hook type bonds.

28. A pack of coffee filters as defined in claim 12 wherein said adhesive system comprises an adhesive layer on or in at least one of said pan-shaped filter and overflow stopper, said adhesive layer being adapted to be activated to achieve sufficient adhesion between said rims of said pan-shaped filter and overflow stopper at a temperature at or below the coffee brewing temperature.

29. A pack of coffee filters as defined in claim 28 wherein said adhesive layer is adapted to be activated by the hot water delivered to the pod holder containing said pan-shaped filter and overflow stopper by the coffeemaker to extract the fresh ground coffee beans between said pan-shaped filter and overflow stopper, thereby causing the formation of a closed coffee pod during the brewing process to enable a mess-free disposal of the extracted ground coffee beans.

30. A pack of coffee filters as defined in claim 12 wherein said center portion of said overflow stopper being adapted to be sufficiently stiffer than said rim of said overflow stopper to prevent the delamination of the seal between said rims of said pan-shaped filter and overflow stopper.

31. A pack of coffee filters as defined in claim 12 wherein said second stack of filters comprises a plurality of overflow prevention sheets, each said sheet having a plurality of said overflow stoppers removable from said sheet.

32. A pack of coffee filters as defined in claim 12 further comprising a sealing presser having a body, a handle and a sealing ring at the lower surface of said body for pressing and sealing the rim of said overflow stopper to the rim of said pan-shaped filter.

33. A pack of coffee filters as defined in claim 12 wherein said rims for both said overflow stopper and pan-shaped filter are sloped to cause self-alignment between said rims during use.

34. A pack of coffee filters as defined in claim 12 further comprising a bridge to connect a pan-shaped filter in said first stack of filters to an overflow stopper in said second stack of filters.

35. A pack of coffee filters as defined in claim 34 further comprising a folding line in or on said bridge to enable one to readily fold said overflow stopper over onto the top of said pan-shaped filter after one has added a desired amount of fresh ground coffee beans to said pan-shaped filter.

36. A pack of coffee filters as defined in claim 35 wherein said folding line is sufficiently long to enable automatic alignment of said rim of said overflow stopper to said rim of said pan-shaped filter when said overflow stopper is folded over to cover said pan-shaped filter.

37. A pack of coffee filters as defined in claim 34 wherein at least part of said bridge is or is rendered significantly more flexible than said overflow stopper to prevent said pan-shaped filter and the fresh ground coffee beans therein from moving when one folds said overflow stopper to cover said pan-shaped filter.

38. A method for using a pack of coffee filters to brew coffee using fresh ground coffee beans in coffeemakers that use coffee pods, said filter pack comprising a first stack of filters comprising a plurality of pan-shaped filters having a chamber with a generally open top end and a rim at or near said generally open top end, a second stack of filters comprising a plurality of overflow stoppers having a center portion permeable to water and a rim around said center portion adapted to seal to said rim of said pan-shaped filter, and an adhesive system for attaching said rim of said pan-shaped filter to said rim of said overflow stopper, said method comprising placing a pan-shaped filter in a pod holder for the coffeemaker, adding a desired amount of fresh ground coffee beans into said chamber of said pan-shaped filter, placing an overflow stopper on top of said pan-shaped filter in such a way that the rims of said pan-shaped filter and overflow stoppers are substantially aligned, and closing the brew head of the coffeemaker to cause the brew head to press said rims of said pan-shaped filter and said overflow stopper, thereby enabling a closed coffee pod to form directly in the pod holder of the coffeemaker.
